(19) United States
(12) Patent Application Publication
(10) Pub. No.: US 2024/0408958 A1
(43) Pub. Date: Dec. 12, 2024

(54) TRANSMISSION COMPRISING A DISCONNECT UNIT AND ELECTRIC VEHICLE COMPRISING SUCH A TRANSMISSION

(71) Applicant: Punch Powertrain E-Vehicles N.V., SINT-TRUIDEN (BE)

(72) Inventor: Jan Willem VAN DER VECHT, SINT-TRUIDEN (BE)

(73) Assignee: Punch Powertrain E-Vehicles N.V., SINT-TRUIDEN (BE)

(21) Appl. No.: 18/702,170

(22) PCT Filed: Oct. 20, 2022
(86) PCT No.: PCT/EP2022/079272

§ 371 Date: Apr. 17, 2024

(30) Foreign Application Priority Data
Oct. 27, 2021 (NL) 2029523

(51) Int. Cl. B60K 17/02; B60K 1/00; F16D 11/00; F16D 11/14; F16D 27/118; F16H 37/08

(52) U.S. Cl. CPC B60K 17/02; B60K 1/00; F16D 11/14; F16D 27/118; F16H 37/082; B60K 2001/001; F16D 2011/002

(57) ABSTRACT

A transmission includes an input shaft, configured for receiving torque applied by a motor, a gear system, a differential, at least one output shaft, and a disconnect unit which is switchable between an engaged and a disengaged state. In the engaged state the input shaft is connected to the output shaft via the gear system and the differential for driving the at least one output shaft, and in the disengaged state the at least one output shaft is disconnected from the input shaft. An (electric) vehicle including such a transmission.

The invention relates to a transmission, comprising an input shaft, configured for receiving torque applied by a motor, a gear system, a differential and at least one output shaft. In particular, the invention relates to a transmission that allows disconnecting, i.e. rotationally decoupling, the input shaft from the at least one output shaft.

Some electric vehicles are provided with two motors, each driving one axle of the vehicle. In such a case, one of the motor often serves as the primary motor, whereas the other serves as a secondary motor. Employing the secondary motor may increase driving performance at the expense of power consumption. As such, a desire exists to allow selective use of the secondary motor, so that a user may prioritize between driving performance and power consumption at will. When the secondary motor is unused a need exists to decouple it and the corresponding transmission from the output shafts, in order to save wear on the motor and the transmission, and to avoid friction, would otherwise reduce efficiency. Of course there are other applications for said decoupling, outside of multi-motor electric vehicles.

Transmissions exist that allow switching between two gears by selectively engaging or disengaging parts of a gear system. A first example of such a transmission is given in U.S. Pat. No. 2,152,771, which proposes to drive a differential casing either directly or via an additional gear set 102, 103. A second example is given in FIG. 4 of US 2019/0158603 A1, which proposes to use a shifting sleeve 41 to selectively couple a motor to an output shaft 12 via a planetary gear set 53 in addition to driving the same output shaft 12 via a differential, in order to allow torque vectoring on the output shaft 12. However, none of these documents allow disconnecting the motor from the output shafts entirely.

It is therefore an object of the invention to, amongst others, provide a transmission that allows decoupling the motor from the output shafts, and to preferably allow disconnecting the transmission or a part thereof at the same time.

The object is achieved by a transmission of the above described type, further provided with a disconnect unit which is switchable between an engaged and a disengaged state, wherein in the engaged state the input shaft is connected to the output shaft via the gear system and the differential for driving the at least one output shaft, and wherein in the disengaged state the at least one output shaft is disconnected from the input shaft.

By virtue of the disconnect unit, the output shaft and the input shaft may be uncoupled from each other. As such, the motor need not turn even when the output shaft does turn. This allows disengaging the motor, thereby saving wear on the motor and eliminating frictional forces arising in the motor, thereby increasing efficiency.

Connected may herein be understood to mean coupled such that rotation of one component corresponds to rotation of another component, possibly via a transmission ratio. Components may be connected via other components, and need not directly and physically engage each other, although they might.

In an embodiment of the transmission, the disconnect unit engages at least a part of the differential in the engaged state.

By engaging at least a part of the differential, the disconnect unit may be used to connect the motor to two output shafts in the engaged state. As such, only a single disconnect unit is needed for the two output shafts. In this embodiment the disconnect unit may engage relatively close to the final stage of the transmission, i.e. the output shaft. As a result, a relatively large part of the transmission may be disconnected in the disengaged state, so that friction losses are prevented to a relatively large degree. In particular, the disconnect unit may engage a casing of the differential in the engaged state.

By engaging the differential casing, two output shafts may be driven at the same time, via a single disconnect unit. Engaging the differential casing has the further advantage of allowing the disconnect unit to engage the differential from the outside thereof, thereby allow external placement of the disconnect unit. This may allow a relatively compact and/or elegant design of the differential.

In another embodiment of the transmission, the gear system is a planetary gear system.

The planetary gear system may aid in providing a suitable transmission ratio from the motor to the output shaft for driving an electric vehicle, possibly without the use of an additional gear box.

It is envisioned the planetary gear system comprises a sun gear, at least one planet gear, a planet carrier, and a ring gear, wherein the at least one planet gear is rotationally mounted on the planet carrier and engages the sun gear and the ring gear.

In particular, the planetary gear system may be a stepped planetary gear system in order to allow for a suitable transmission ratio. To this end, the at least one planet gear may be a stepped gear, comprising two sets of teeth having a different amount of teeth. Each set may engage another of the sun gear and the ring gear.

In the engaged state, the disconnect unit may engage at least a part of the planetary gear system.

By engaging the planetary gear system in the engaged state, the disconnect unit may be used to disconnect another part of the planetary gear system, thereby thus disconnecting a larger part of the transmission, and reducing friction and wear accordingly.

It is preferred the disconnect unit engages a planet carrier of the planetary gear system in the engaged state.

Accordingly, the planetary gear system may be connected/disconnected at the planet carrier, thereby allowing disconnecting the entire planetary gear system from the output shaft. Additionally or alternatively, using the planet carrier as a point of engagement for the disconnect unit may allow to put the disconnect unit at a distance from a central axis of the planetary gear system, thereby allowing a relatively compact and/or elegant design of the planetary gear system.

Practically, the input shaft may be fixed or rotationally fixed to an input of the planetary gear system, such as a sun gear of the planetary gear system.

In a particularly advantageous embodiment of the transmission, the planet carrier and the casing are rotationally fixed with respect to each other in the engaged state, whereas in the disengaged state the planet carrier and the casing are rotationally uncoupled.

Accordingly, the disconnect unit works by selectively coupling the planet carrier and the differential casing in rotation.

This embodiment may provide the advantage that a compact design of the transmission is possible, since the planet carrier and the differential casing may be similar in size and position. As such, the disconnect unit may be placed external of the differential casing and the planetary gear system. This allows easy installation and servicing of the disconnect unit, and reduces design constraints on the differential and the planetary gear system.

Accordingly, it is preferred if the disconnect unit is arranged in an off-axial position. Off-axial, sometimes referred to as offset, may herein be understood as a position at a distance from the axis of rotation of the components upon which the disconnect unit operates, e.g. the differential casing and/or the planet carrier.

It is noted that the advantages obtained by using an offset actuator may be achieved regardless of the components upon which the disconnect unit engages. Accordingly, the offset actuator can be employed in any disconnect unit, or any other unit that requires axial actuation. The features of the disconnect unit described above and below, may therefore be employed together with the offset position of the actuator, regardless of the components upon which the disconnect unit acts. These additional features may include the sleeve for engaging splines and the lever for moving the sleeve.

As an alternative to an offset disconnect unit, an axial disconnect unit may be used, which is arranged coaxially with said differential casing and/or the planet carrier. Such a coaxial disconnect unit may extend entirely around e.g. the differential casing and/or the planet carrier, or at least around the input and/or output shafts.

In order to connect the differential casing and the planet carrier, one or both of them may comprise external splines, wherein in the engaged state the disconnect unit engages said external splines.

By providing external splines, the disconnect unit may easily engage and lock a rotational position of the two components from the outside.

The disconnect unit may further comprise a shift sleeve configured to cooperate with said splines on the casing and/or the planet carrier.

Using a shift sleeve, the external splines may be engaged in order to transfer rotation of the splined component to another component.

The shift sleeve may be configured to engage external splines of both the planet carrier and the differential casing in the engaged state. The sleeve may be brought to a disengaged state by translating it along an axial direction, so that the sleeve disengages the external splines of at least one of the components, i.e. of the planet carrier and/or of the differential casing.

It may be advantageous to couple the shift sleeve permanently in rotation to the planet carrier. Accordingly, when the disconnect unit is in the disengaged state, the shift sleeve is also disconnected from the output shaft. Accordingly, a relatively large part of the transmission is disconnected from the output shaft.

In this case, switching from the engaged state to the disengaged state may be achieved by selectively sliding the shift sleeve over the external splines of the differential casing.

As an alternative, the shift sleeve may be permanently rotationally coupled to the casing of the differential.

In this alternative, the planet carrier may be designed relatively small, thereby allowing the differential to be arranged relatively close to the planet carrier. As a result, the transmission may be relatively short as seen in the axial direction.

In another embodiment, the transmission further comprises a bearing arranged between the planet carrier and the casing, said bearing being pretensioned.

The pretension in the bearing may facilitate the casing and the planet carrier remaining coaxial to each other, i.e. it may reduce or prevent the two components from becoming out of coaxial alignment. Accordingly, additional bearings between the casing and the housing and/or the planet carrier and the housing may be dispensed with. As such a more light-weight and/or elegant design may be made.

It is noted this embodiment may be applied to any transmission as described herein, and even to those without a disconnect unit.

Using the pre-tensioned bearing, the transmission, in particular the planet carrier may be made self-aligning. Self-alignment is particularly important when transmitted torques are low, since at relatively high torques, the planetary gear system self-aligns already due to the interaction between the planets, sun and ring gear. However, the differentials are not self-aligning, be it al low or high torques. As such, at low (or zero) torques, the differential and also the planetary gear system is inclined to fall out of alignment due to gravity, thereby essentially buckling the axis running through the center of the planetary gear system and the differential.

It would be possible to support the differential and the planetary gear system by one or more bearings on an outer casing of the transmission. Alternatives exist in placing multiple bearings at different axial positions, which together could prevent the ill-alignment of the differential and/or planetary gear system at low or zero torques. These solutions however introduces more moving parts susceptible to wear, and increase the weight and size of the system. As this application relates to a compact and/or elegant design, this would be detrimental to the objective of the transmission described herein.

A pretensioned bearing between the carrier of the planetary gear system and the differential housing allows less axial and/or radial play in the bearing. As a result of limited axial/radial play, the amount of tilting play is also limited. As such, a pretensioned bearing is also referred to as an axially pretensioned bearing. The applicant has found that by pretensioning, that is by limiting tilting play, ill-alignment of the differential can be reduced, as the tilting play in the bearing was found to be at least in part responsible for allowing sufficient play for the ill-alignment. Thus, the limit on axial and/or radial play is effective since it caused in part tilting play, which allowed misalignment.

The axial pretension can be applied via a variety of ways. One method may be to provide axial tension on the casing of the differential and the carrier of the planetary gear system. This axial tension can be applied from e.g. an outer casing of the transmission via for instance a lid thereof. In particular, the axial tension can be provided via bearings arranged for supporting the casing of the differential and/or the planet carrier. An alternative of providing axial tension may be to provide a biasing element, such as a spring, which acts on one of the previously described bearings.

To summarize, an opposing axial force can be applied on the planet carrier and the differential casing from the casing of the transmission via bearings between the outer casing of the transmission and the respective transmission component. As a result, a bearing between the planet carrier and the differential casing is pretensioned, as are other bearings of the carrier and differential may. Due to the pretensioning, there is less axial/radial play, and thereby limited tilting play. The limited tilting play allows less buckling and with that provides better alignment at low torques.

It is noted that the tension in the bearings at the outer casing of the transmission may also limit axial/radial play, and therefore tilting play of those particular bearings, which may further contribute to keeping the transmission components aligned.

It is further noted that at higher torques, the planetary gear system is self-aligning. Accordingly, the differential may be aligned better according to the disclosure of this application, by using a pretensioned bearing as described above. The differential may effectively benefit from the self-alignment of the planetary gear system via the pretensioned bearing.

It is noted that without a pretensioned bearing buckling and/or ill-alignment is also counteracted to some extent, but the pretensioned bearing significantly reduces these effects.

The skilled person knows that when not properly aligned, several parts of the transmission may increase noise, vibration or harshness (NVH), and/or run the risk of wearing more quickly, being damaged, or may become jammed. A relatively poor alignment of the gear components may lead for example to double flank contact or tip to root contact of the gears, which the skilled person knowns to be undesirable. Thus, the advantages obtained by pretensioning the bearing between planet carrier and differential casing are readily understood.

Further, the amount of pretension needed is dictated by the dimensions of the bearings used and the weight of the components (planetary gear system and differential). At an equal axial pretension, a larger bearing can counteract a larger tilting force resulting from the weight of said components. The bearings between the housing and the planetary gear system and/or the differential casing show similar behavior, i.e. larger bearings provide a better alignment at a similar pretension. Thus, the skilled person, when using the invention of using pretensioned bearings, is readily able to determine the amount of pretension required based on the dimensions of the bearings, the weight of the components involved, and of course the desired results.

Finally, it is noted that when the pretensioned bearing is applied to a transmission with a disconnect unit arranged between the planet carrier and the differential casing, the compactness/elegance of the transmission is increased in addition to the advantageous relating to alignment.

In another embodiment, the disconnect unit comprises an actuator for switching between the engaged and the disengaged state. Using the actuator, the disconnect unit may be operated e.g. electronically.

The actuator may be mounted offset from a central axis of the casing and/or the planet carrier. Accordingly, an offset disconnect unit may be obtained. Advantages thereof are described above. As explained above, the offset actuator may be applied to any type of disconnect unit, regardless upon which components it acts.

In particular, the actuator may be rotationally stationary. By mounting the actuator rotationally stationary, the total rotating mass of the transmission is reduced, thereby increase efficiency and/or reducing wear.

In an embodiment, the actuator comprises a solenoid. A solenoid may provide sufficient force to switch between the states of the disconnect unit. Moreover, a solenoid may easily be operated electrically, thereby making the disconnect unit especially suitable for electric vehicles.

When the actuator comprises an offset solenoid, which is thus mounted away from the central axis, further synergistic advantages exist. In particular, the actuated part of the offset solenoid, e.g. a pin, need not rotate. Accordingly, the design of the solenoid may be simplified. As an example, no bearings are needed to allow rotation of the pin.

The solenoid may comprise an actuatable pin and a first stop, wherein the pin engages the first stop when the solenoid is actuated.

By providing a stop for the pin to engage on when the solenoid is actuated, the actuated position for the pin may be well-defined. It is noted that the fact that the pin is not rotating, which ultimately results from the offset position of the solenoid, allows the pin engaging the stop without introducing friction.

As compared to a co-axial solenoid, the offset solenoid may have additional advantages. Firstly, the offset solenoid need not be shimmed since due to ability to use a stop for defining the engaged position of the pin, there is a less stringent constraint on the windings of the solenoid. A coaxial solenoid however would require the pin to rotate, and therefore keep clear of non-rotating parts of the solenoid. The coaxial solenoid must therefore keep the pin, or any other actuated part, in a desired actuated position without the use of a stop. Moreover, said desired position needs to be achieved within relatively small tolerances, which requires shimming of the solenoid. Moreover, keeping the pin in the actuated position without the use of a stop requires a relatively large amount of energy, since the hold-power is relatively high in this case. The hold power can be reduced by the interaction with the stop, since no precise position need be effected by the solenoid. After all, the engaged position can be defined by the stop.

The solenoid may comprise the actuatable pin and further a second stop and a biasing means, wherein the biasing means is configured to bias the actuatable pin towards the second stop, and wherein in the disengaged state the biasing means force the actuatable pin into engagement with the second stop.

Accordingly, a disengaged position may be defined by an additional stop, which contributes to a relatively elegant design. The biasing means further allow retraction of the pin without requiring any further external force. As such, removing power from the solenoid may default into the disengaged state relatively quickly.

Of course it is possible to invert the solenoid's operation, so that powering the solenoid moves the disconnect unit to the engaged state and powering the solenoid moves the disconnect unit to the disengaged state.

In another embodiment, the disconnect unit comprises a lever for switching between the engaged and the disengaged state. In particular, the lever may drive the shift sleeve. The lever may drive the shift sleeve via a slide shoe engaging in a track of the sleeve. The slide shoe may be rotatably engaged with the lever in order to allow for sufficient play between the sleeve and the lever as one component rotates with respect to the other.

The lever may aid in arranging the solenoid in the offset position, thereby allowing to choose a suitable location for the solenoid. It is noted the lever may be used for the same reasons with any other type of actuator, or even when driven manually. Moreover, the lever may provide a suitable amount of leverage, which may in turn allow selecting a suitable solenoid, such as one with a desired maximum force and/or a desired range of motion.

The lever may be actuatable via a pin-slot joint. Accordingly, rotation of the lever and translation in a direction perpendicular to the direction of actuation may be free. As a result, the solenoid may be fixed in location, thereby allowing the solenoid to be rigidly fixed to an external casing of the transmission.

As an alternative to the lever, a shift-fork could be used, which may be guided unidirectionally, as opposed to the pivoting motion of the lever.

The invention also relates to a vehicle comprising a motor and a transmission as described above, wherein the vehicle is drivable by the motor via the transmission. The vehicle may be an electric vehicle. The transmission may have any one or more of the above-described features, alone or in any suitable combination.

The vehicle may comprise a second motor for driving the vehicle. The first motor may be a so-called secondary motor, which may be disconnected from the output shafts using the disconnect unit in the transmission.

It is noted that the terms primary and secondary when relating to the motors are used only to distinguish the motors, and in no way require that the secondary motor is ancillary to, or rated lower in power or importance than, the primary motor. Regardless, the secondary motor may indeed be smaller, have lower power output, be used less often, or otherwise be ancillary.

The vehicle may be an electric vehicle. The motor and/or the secondary motor may accordingly be electric motors.

The invention will be further elucidated with reference to the attached drawings, in which:

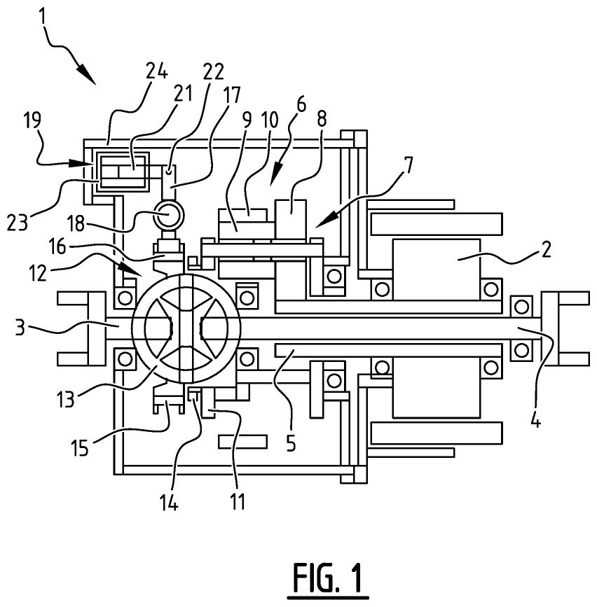

FIG. 1 shows a schematic of a transmission;

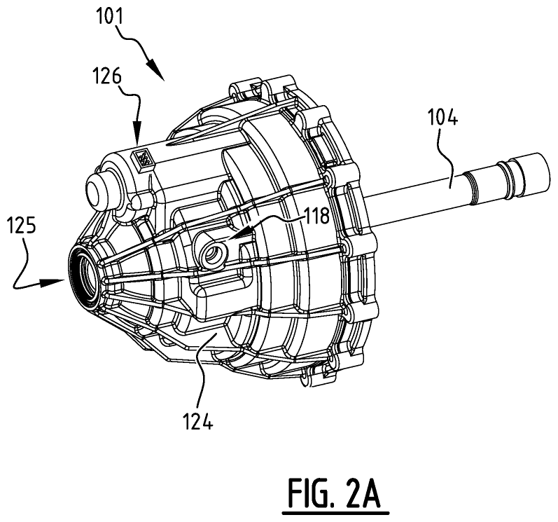

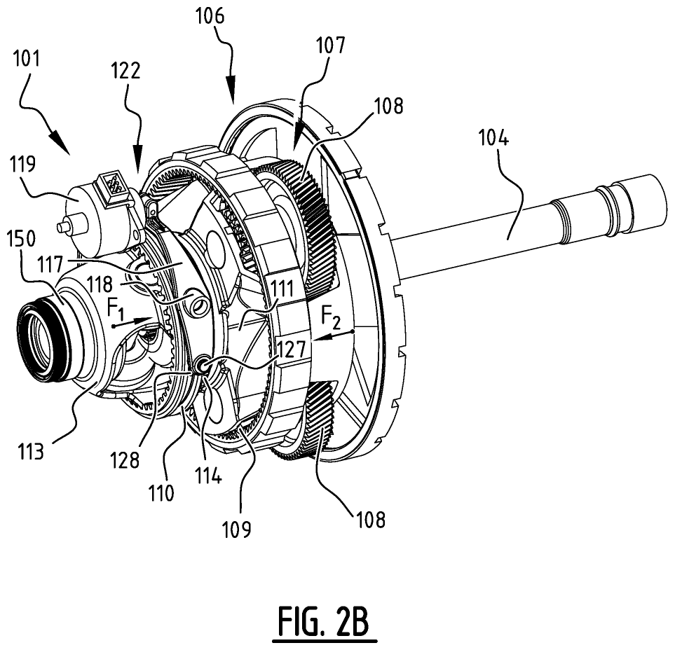

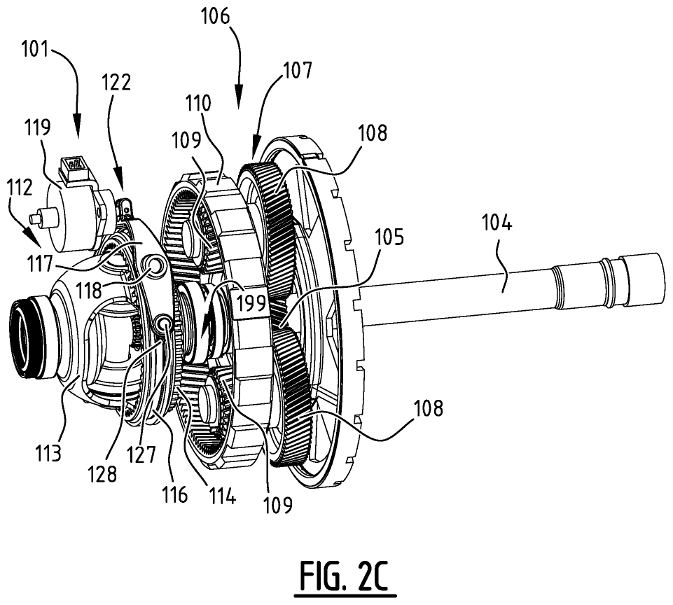

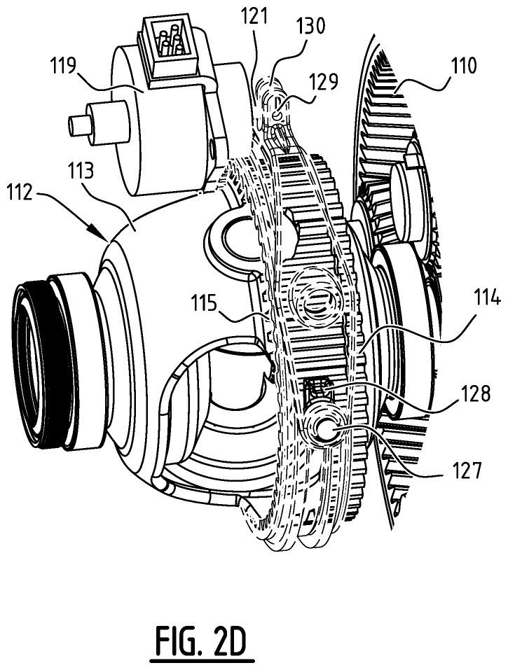

FIGS. 2A-2D schematically show different perspective views of a transmission, detailing various components; and

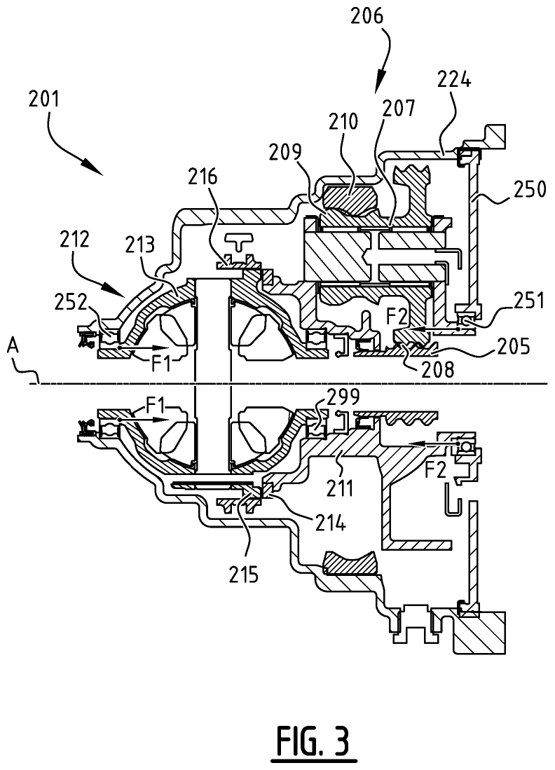

FIG. 3 schematically shows a cross sectional view of a transmission.

Throughout the figures, like elements will be referred to using like reference numerals. Like elements of different embodiments are referred to using reference numerals increased by one hundred (100).

The schematic of FIG. 1 shows a transmission 1 and an electric motor 2 configured for driving a first and second output shaft 3, 4 through the transmission 1. The motor 2 drives a sun gear 5 of a planetary gear system 6. Torque is transmitted further via stepped planet gears 7 (only one shown) with a first set of teeth 8 engaging the sun gear 5, and a second set of teeth 9 engaging a ring gear 10. The stepped planet gears 7 are carried by a planet carrier 11.

The output shafts 3, 4 are driven via a differential 12 which includes a casing 13 configured for receiving torque in order to drive the output shafts 3, 4.

The casing 13 of the differential 12 and the planet carrier 11 are provided with corresponding splines 14, 15 on their exterior. A shifting sleeve 16 is movably arranged over the external spline 15 of the differential casing 13, so that it can selectively engage or disengage the external spline 14 of the planet carrier 11. Accordingly, rotation of the planet carrier 11 and the differential casing 13 can be coupled or uncoupled by moving the shifting sleeve 16, thus providing an engaged and a disengaged state of a disconnect unit. The shifting sleeve 16 is driven via a lever 17 which pivots about a pivot point 18. The lever 17 is actuated by a solenoid 19 mounted offset from a central axis A of the differential casing 13. The solenoid 19 is fixed in position, as shown by it being connected to an outer transmission casing 24. The solenoid 19 includes an actuatable pin 21 connected to the lever via a pin-and-slot joint 22. Accordingly, movement of the pin 21 from the right to left in FIG. 1 pivots the lever, thereby moving the sleeve 16 from left to right, so that the sleeve 16 engages both external splines 14, 15 of the differential casing 13 and the planet carrier 11. The solenoid 19 further includes a first stop 23 upon which the pin 21 engages when the solenoid 19 is powered. Although not shown in FIG. 1, the solenoid 19 may be further provided with a biasing means biasing the actuatable pin away from the first stop, and optionally a second stop which limits movement of the actuatable pin 21 at a certain distance from the first stop 23.

FIGS. 2A-2D show a transmission 101 which has a casing 124. An output shaft 104 protrudes from the casing 124. Further an opening 125 can be seen for accommodating another output shaft. The casing 124 also forms a pivot 118 upon which a lever (see FIGS. 2B-2D) can rotate. Further, an electrical connection 126 is exposed, through which the solenoid (see FIGS. 2B-2D) can be powered.

In FIG. 2B, the casing 124 has been removed to expose the internals of the transmission 101. In FIG. 2C additionally a part of the planet carrier 111 has been removed. Accordingly, stepped planetary gears 107 with first 108 and second 109 sets of teeth can be seen engaging a ring gear 110 of a planetary gear system 106. The planetary gear system 106 is driven via the sun gear 105 (FIG. 2C). the planet carrier 111 has an external spline 114. A differential 112 with a casing 113 is also shown. The differential 112 is provided with an external spline 115 (FIG. 2D) which correspond with the spline 114 of the planet carrier 111. A shift sleeve 116 engages the spline 115 of the differential casing 113 and selectively engages the spline 114 of the planet carrier 111, depending on its axial position. Accordingly, an engaged and a disengaged state are provided. Movement of the shift sleeve is driven via a lever 117 which pivots about a pivot point 118. The lever 117 is connected to the shift sleeve 116 via slide shoes 128 connected to the lever 117 via a pin 127 allowing some rotation of the shoe 128. The shoe 128 slides in a track 128′ when the shift sleeve 116 rotates, thereby allowing the lever 117 to be rotationally stationary. Movement of the lever 117 is effected by a solenoid 119 which engages the lever 117 via a pin-and-slot joint 122, which includes a hook 130 attached to an actuatable pin 121 of the solenoid 119, which forms the slot, and a pin 129 fixed to the lever, which forms the pin of the pin-and-slot joint 122 (FIG. 2D).

FIG. 2C further shows a bearing 199 between the planet carrier 110 and the casing 113 of the differential 112. The bearing 199 is pretensioned, so that a coaxial alignment of the planet carrier 110 and the casing 113 is guaranteed. Pretension is applied by forcing the planet carrier 110 and the differential casing 113 towards each other in the axial direction, as indicated by arrows F₁ and F₂ in FIG. 2B. The required force on the differential casing 113 is applied by the housing 124 via a bearing 150. The required force on the carrier is applied by a lid of the housing 124, also via a bearing (not visible).

FIG. 3 shows a transmission similar to that of FIGS. 2A-2D. As its components are identical in type to that of FIGS. 2A-2D, reference is herein made only to components not easily visible in that of the preceding figures. In the cross section of FIG. 3, the pretensioned bearing 299 can be seen centrally between the planet carrier 211 and the housing 213 of the differential 206. The bearing 299 is pretensioned in the axial direction, by forcing the housing 213 of the differential 206 towards the planet carrier 211 using a pretension force. The pretension force is applied by the casing 224 of the transmission 201 on the one hand, which produces a force F₁ on the housing 213 of the differential 206 which in FIG. 3 is oriented to the right, and a lid 250 of the transmission housing 224 on the other hand, which produces a force F₂ on the planet carrier 211 which in FIG. 3 is oriented to the left. Both these forces F₁, F₂ are applied via respective bearings 251, 252 between the housing 224 and the planet carrier 211 and the housing 213 of the differential 206 respectively. It is noted some details have been left out in FIG. 3 for simplicity. For those details, reference is made to the other figures and the description above.

Although the invention has been described above with reference to specific examples and embodiments, the scope of this application is not limited thereto. In fact, the scope is also defined by the following claims.

1. A transmission comprising:
an input shaft, configured for receiving torque applied by a motor;
a gear system;
a differential;
at least one output shaft, and
a disconnect unit which is switchable between an engaged and a disengaged state,
wherein in the engaged state the input shaft is connected to the output shaft via the gear system and the differential for driving the at least one output shaft, and wherein in the disengaged state the at least one output shaft is disconnected from the input shaft.

2. The transmission according to claim 1, wherein in the engaged state the disconnect unit engages at least a part of the differential.

3. The transmission according to claim 2, wherein the differential comprises a casing, wherein in the engaged state the disconnect unit engages the casing of the differential.

4. The transmission according to claim 1, wherein the gear system is a planetary gear system; and wherein in the engaged state the disconnect unit engages a planet carrier of the planetary gear system.

5. The transmission according to claim 4, wherein in the engaged state the disconnect unit engages at least a part of the planetary gear system.

6. (canceled)

7. The transmission according to claim 4, wherein the input shaft is rotationally fixed an input of the planetary gear system, such as a sun gear of the planetary gear system.

8. The transmission according to claim 4, wherein in the engaged state, the planet carrier and the casing are rotationally fixed with respect to each other, and wherein in the disengaged state the planet carrier and the casing are rotationally uncoupled.

9. The transmission according to claim 4, wherein the transmission further comprises a bearing arranged between the planet carrier and the casing, said bearing being pretensioned.

10. The transmission according to claim 9, wherein the casing and/or the planet carrier comprises external splines, wherein in the engaged state the disconnect unit engages said external splines; and wherein the disconnect unit comprises a shift sleeve configured to cooperate with said splines on the casing and/or the planet carrier.

11. (canceled)

12. The transmission according to claim 11, wherein the shift sleeve is permanently rotationally coupled to the planet carrier; and wherein the shift sleeve is permanently rotationally coupled to the casing of the differential.

13. (canceled)

14. The transmission according to claim 1, wherein the disconnect unit comprises an actuator for switching between the engaged and the disengaged state.

15. The transmission according to claim 14, wherein the actuator is mounted offset from a central axis of the casing and/or the planet carrier.

16. The transmission according to claim 14, wherein the actuator is rotationally stationary.

17. The transmission according to claim 12, wherein the actuator comprises a solenoid.

18. The transmission according to claim 17, wherein the solenoid comprises an actuatable pin and a first stop, wherein the pin engages the first stop when the solenoid is actuated.

19. The transmission according to claim 17, wherein the solenoid comprises the actuatable pin and further a second stop and a biasing means, wherein the biasing means is configured to bias the actuatable pin towards the second stop, and wherein in the disengaged state the biasing means force the actuatable pin into engagement with the second stop.

20. The transmission according to claim 1, wherein the disconnect unit comprises a lever for switching between the engaged and the disengaged state.

21. The transmission according to claim 20, wherein the lever is actuatable via a pin-slot joint.

22. A vehicle comprising a motor and the transmission according to claim 1, the vehicle being drivable by the motor via the transmission, the vehicle further comprising a second motor for driving the vehicle.

23. (canceled)

24. The vehicle according to claim 22, the vehicle being an electric vehicle.
